(19) United States
(12) Patent Application Publication
(10) Pub. No.: US 2008/0133272 A1
(43) Pub. Date: Jun. 5, 2008

(54) Method And System For Use Of A Health Profile With Health-Related Information Tools

(76) Inventor: Philip Marshall, Portland, OR (US)

Correspondence Address: WILMERHALE/BOSTON, 60 STATE STREET, BOSTON, MA, 02109, US

(21) Appl. No.: 11/619,012

(22) Filed: Jan. 2, 2007

Related U.S. Application Data
(60) Provisional application No. 60/868,521, filed on Dec. 4, 2006.

(51) Int. Cl. G06F 19/00

(52) U.S. Cl. 705/3

(57) ABSTRACT

The invention features a computer-implemented method that stores a patient profile in electronic storage; the patient profile includes personal and medical information about the patient. The method provides access to a set of different health-related information tools. Each tool is a corresponding computer program which when executed uses information from the patient profile to generate corresponding health-related information about the patient and stores additional information about the patient in the patient profile. The additional information stored by each of the tools includes health-related information generated by that tool. The method also provides an interface enabling the patient to execute any selectable one of the health-related information tools among the set of different health-related information tools. The additional information stored in the patient profile by a first health-related information tool of the set is used by a second health-related information tool of the set during execution to generate its output.

### RELATED APPLICATIONS

This application claims the benefit of U.S. Provisional Application No. 60/868,521, entitled “Method And System For Use Of A Health Profile With Health-Related Information Tools”, filed Dec. 4, 2006, the contents of which are incorporated herein by reference.

This application is related to U.S. patent application Ser. No. 11/566,286, filed on Dec. 4, 2006, entitled “Method And System For Optimizing Fund Contributions To A Health Savings Account”, herein incorporated by reference.

This application is related to U.S. patent application Ser. No. TBA, entitled “System And Method For Analyzing And Presenting Physician Quality Information”, attorney docket no. 2000874-155US1, filled on Dec. 22, 2006, herein incorporated by reference.

### BACKGROUND

1. Field of Invention

This invention generally relates to using a health and personal information profile to provide personalized information to health-related information tools.

2. Description of Related Art

Consumer health-related information tools and personal planning tools are growing in importance and popularity, with computer networks such as the Internet providing access to such tools. These tools include, for example, Health Saving Account calculators, medical expense calculators, and retirement savings account calculators. These tools can help a user to predict future expenses, estimate account balances, and forecast the likelihood of future events based on a set of information known to the user.

Many such tools rely on assumptions about the user to generate the desired information. In some instances, these assumptions are based on the general population. For example, a health-care cost estimation tool can estimate the user's health care costs based on the national average of health care costs. Some tools solicit input from the user to personalize the tools' output and to increase the accuracy of the tools' output. Such tools typically receive input from the user through text input boxes, drop-down lists, checkboxes, and other similar user input fields.

### BRIEF SUMMARY OF EMBODIMENTS

In one aspect, the invention features a computer-implemented method. The method stores a patient profile in electronic storage; the patient profile includes personal and medical information about a patient. The method provides access to a set of different health-related information tools. Each of the different health-related information tools is a corresponding computer program which when executed uses information from the patient profile to generate corresponding health-related information about the patient and stores additional information about the patient in the patient profile. The additional information stored by each of the different health-related information tools includes health-related information generated by that tool. The method also provides an interface enabling the patient to execute any selectable one of the health-related information tools among the set of different health-related information tools. The additional information stored in the patient profile by a first health-related information tool of the set is used by a second health-related information tool of the set during execution to generate its output.

In another aspect of the invention, the additional information stored by the second health-related information tool in the patient profile is used by the first health-related information tool during execution to generate its output.

In a further aspect of the invention, a system includes a computer system, a patient profile stored on the computer system, first program code, second program code, and third program code. The patient profile includes personal and medical information about a patient. The first program code is on a computer-readable medium and when executed on the computer system uses information from the patient profile to generate corresponding health-related information about the patient and stores at least some of the generated corresponding health-related information in the patient profile as additional information. The second program code is on a computer-readable medium and when executed on the computer system uses information from the patient profile, including at least some of the additional information of the first program code, to generate corresponding health-related information about the patient and stores at least some of the generated corresponding health-related information in the patient profile as additional information. The third program code is on a computer-readable medium and when executed on the computer system presents at least some of the health-related information generated by at least one of the first and second program code to the user.

These and other features will become readily apparent from the following detailed description wherein embodiments of the invention are shown and described by way of illustration.

### BRIEF DESCRIPTION OF THE DRAWINGS

For a more complete understanding of various embodiments of the present invention, reference is now made to the following descriptions taken in connection with the accompanying drawings in which:

FIG. 1 illustrates a health and personal planning system.

FIG. 2 illustrates an information flow diagram of the operation of the health and personal planning system.

FIG. 3 illustrates sources of health-related and personal information for a user profile of the health and personal planning system.

FIG. 4 illustrates data flow for an embodiment of the health and personal planning system.

FIG. 5 illustrates data flow for another embodiment of the health and personal planning system.

FIG. 6 illustrates a conceptual diagram of one implementation of a health and personal planning system.

### DETAILED DESCRIPTION

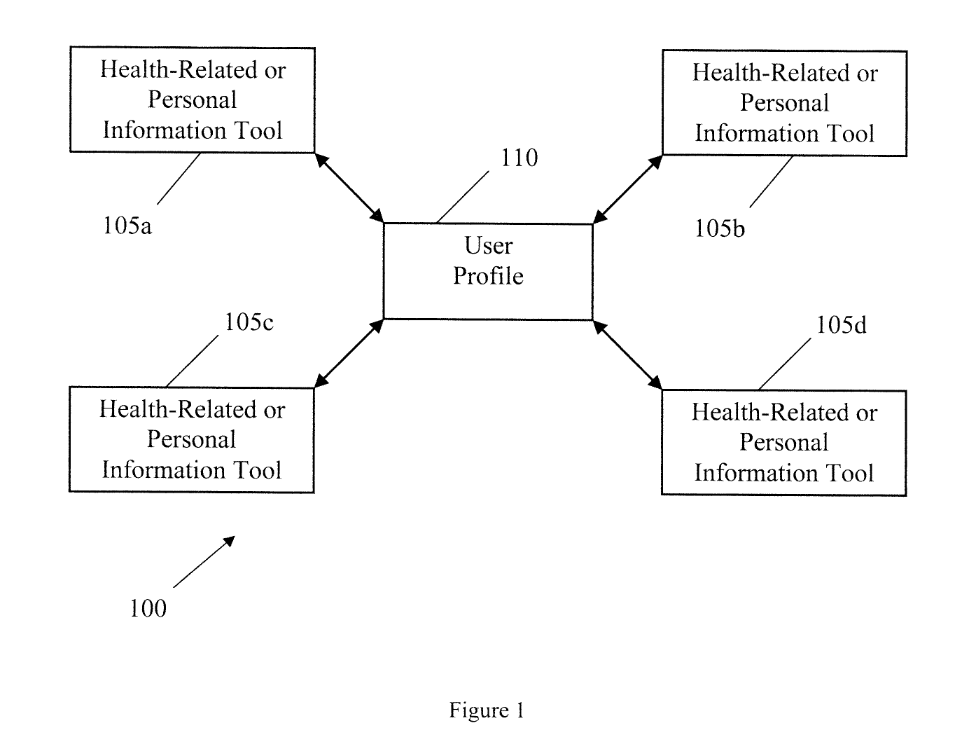

FIG. 1 illustrates a health and personal planning system 100. System 100 has a suite of health-related information tools 105a-d, and a user profile 10. User profile 10 contains personal information and health-related information about the user. Tools 105a-d perform operations based on the user's information and present output to the user. Tools 105a-d use information from and add information to profile 110. Thus, profile 10 enables tools 105a-d to have input information that would not otherwise be available absent the interaction with profile 110. This interaction increases the amount and accuracy of information in the profile, which in turn allows tools 105a-d to provide more accurate data to the user and to tools 105a-d.

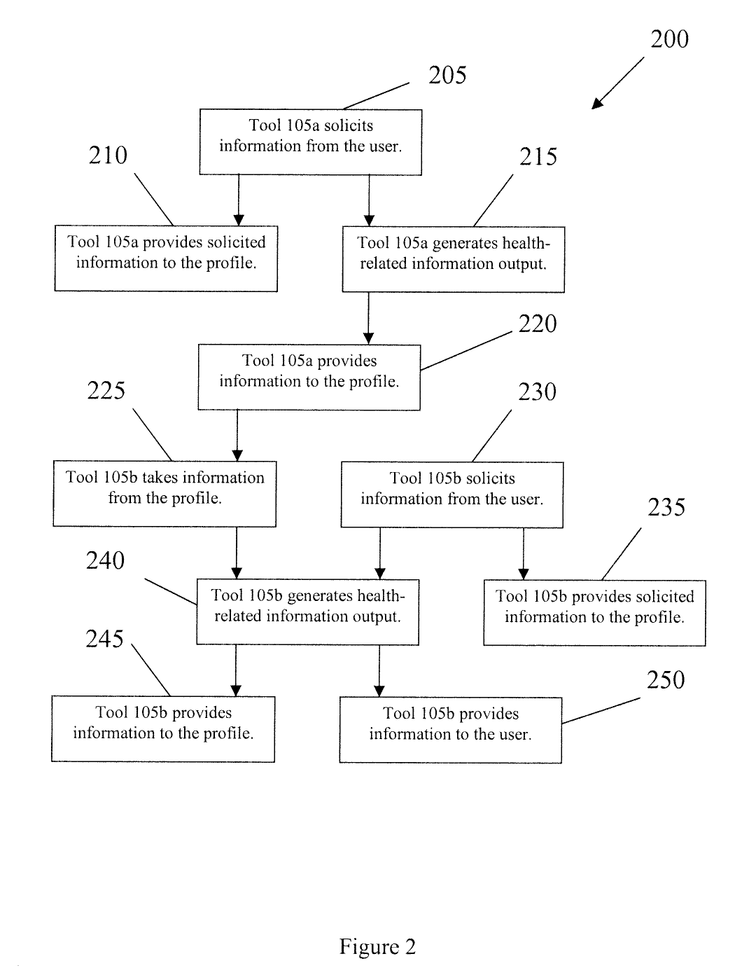

FIG. 2 is an information flow diagram 200 of the operation of health and personal planning system 100 when a user first uses tool 105a and then subsequently uses tool 105b. Tool 105a solicits information from the user (step 205). Tool 105a provides the information obtained from the user to profile 110 (step 210) and uses the information to generate output (step 215). As described in greater detail below, tool 105a can also use information provided to profile 110 from sources other than the user to generate its output (not shown). This output is stored in profile 100 (step 220). Tool 105b obtains information from profile 110 (step 225). This information includes the output generated by tool 105a and can include a portion of the information solicited by tool 105a as well as information from sources other than the user. In addition, tool 105b solicits information from the user (step 230). Tool 105b provides the information obtained from the user to profile 110 (step 235) and uses the information provided by profile 110 to generate output (step 240). This output is stored in profile 110 (step 245) and is also presented to the user (step 250).

The information in profile 110 grows and changes through the contributions of tools 105a and 105b. Tools 105a and 105b in turn benefit from the growth and development of profile 110. Health and personal planning system 100 thereby enables inferences or conclusions generated by tool 105a to be used by tool 105b when generating its output. Thus, health and personal planning system 100 provides input to tool 105b that would not be known to the user absent system 100, thereby increasing the accuracy of the information available to the user.

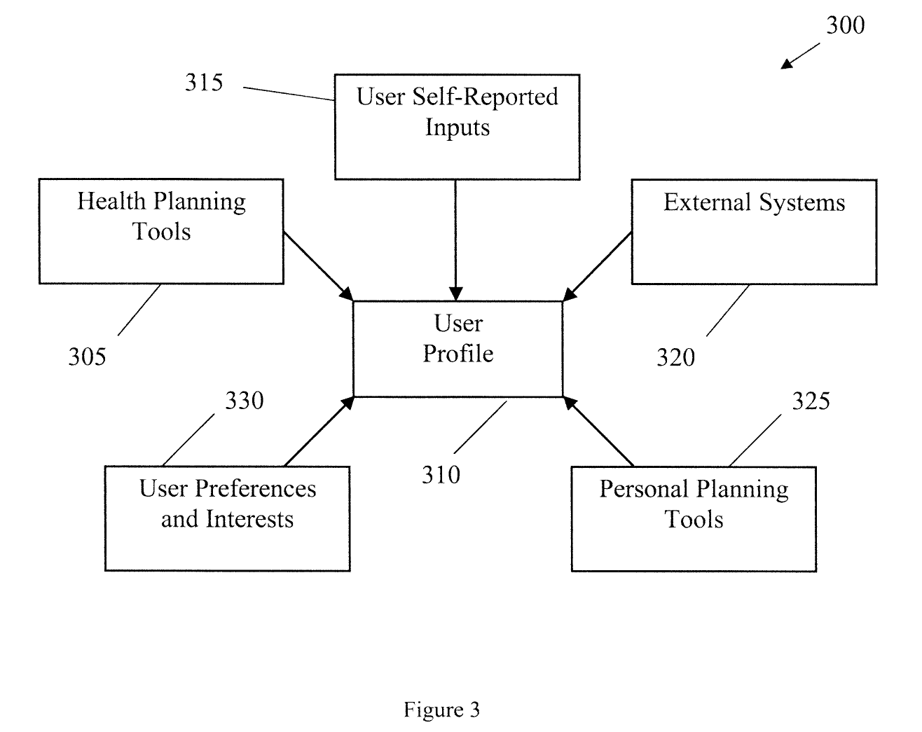

FIG. 3 illustrates sources 300 of health-related and personal information about the user. As described above, health-planning tools 305 supply information to a profile 310. Health-planning tools 305 include, for example, a symptom checker application that solicits symptoms the user is currently experiencing and stores the symptoms along with a set of possible medical conditions the user may have based on the symptoms in profile 310. Another illustrative tool is a cost comparison application that solicits known health risks of the user, known conditions of the user, and current medications the user is taking. The cost comparison tool generates a set of health care utilization and medical expense projections, which are stored in profile 310.

User self-reported information 315 is also included in profile 310. This information is obtained from the user through HTML-based system interface screens. These screens are associated with various health and personal planning tools as well as stand-alone screens designed solely for the purpose of soliciting user information. The information includes, for example, the user's date of birth, gender, race, location of residence, known health conditions, family history, and social history.

External systems 320 supply information gathered about the user based on the user's interactions with various service providers, e.g., health care providers, retirement planning service providers, etc. The service providers, without involvement of the user, supply this information. This information includes the user's medical records, which contain current and past diagnosed conditions, medications prescribed, surgeries, immunizations, and test and lab results. This information also includes the user's retirement account information, which includes account balances, current investment vehicles, and other retirement-related information.

External systems 320 also supply information about the general public. For example, information from public health organizations, such as the Centers for Disease Control (CDC) is supplied to profile 310. This information includes reports of current health conditions in the user's location of residence, e.g., influenza or other outbreaks. Similarly, other organizations provide health-related information of general interest to the public to profile 310. For example, current pollen counts or UV index forecasts for the user's region are provided to profile 310. This information is used by health-planning tools to increase the accuracy of their output.

Personal planning tools 325 supply profile 310 with information generated from a variety of planning simulations performed by the user. These simulations include retirement account balance projections, dependent long-term care cost estimation, and flexible spending account balance simulations.

User preferences and interests 330 gathered from the user's interactions with health and personal planning system 100 are supplied to profile 310. Preferences and interests 330 are collected based on the subject matter of websites visited by the user, the subject matter of articles and publications requested by the user, expressed preferences supplied by the user, and the subject matter of automated reports the user has requested be sent. System 100 uses a typical login-based session to identify the user and correlate the user's actions with the user's profile 310. System 100 also uses cookie-based techniques known in the art to collect preferences and interests of the user. The contents of these cookies are automatically uploaded to profile 310 during a login-based session.

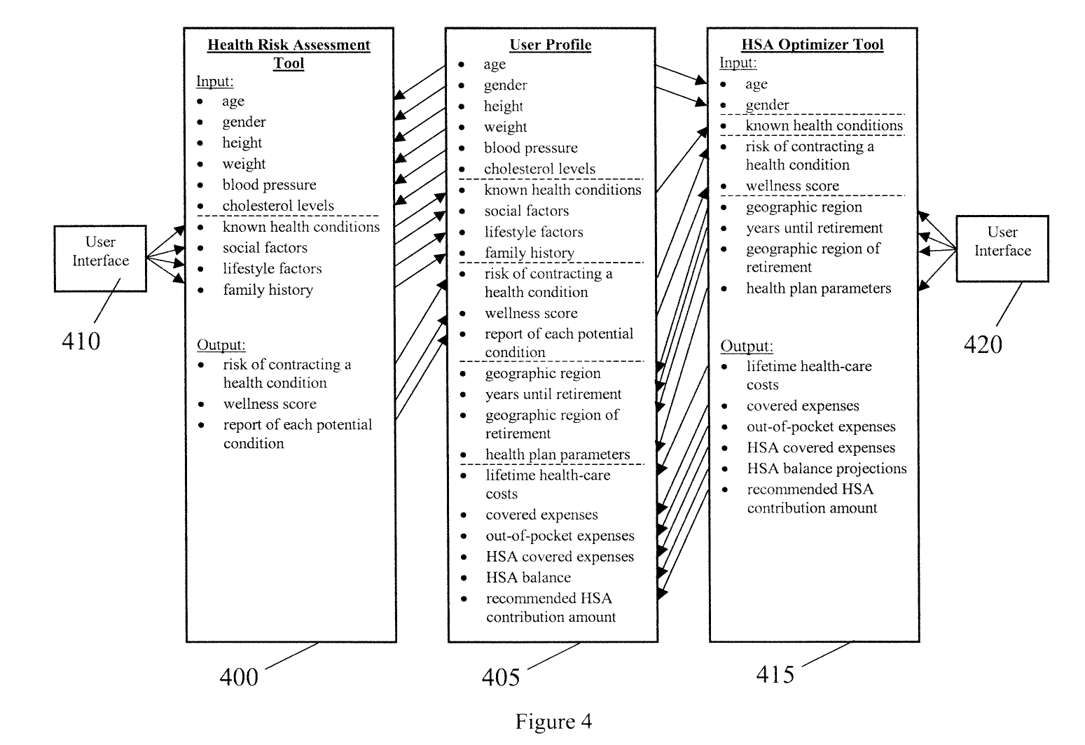

FIG. 4 illustrates data flow for a specific example of health and personal planning system 100. For clarity, the examples of the heath and personal planning tools are simplified. Each illustrative tool is capable of processing more varied input information, providing more varied output information, and executing more elaborate algorithms than is described herein. A health risk assessment tool 400 generates a set of health conditions and/or diseases the user is likely to contract based on a number of factors. One example of health risk assessment tool 400 is the Health Risk Assessment tool available from WebMD, Inc. Health risk assessment tool 400 obtains input information, such as the user's age, gender, height, weight, blood pressure, and cholesterol levels from profile 405. Other health and personal planning tools (not shown) supply this information to profile 405. In addition, health risk assessment tool 400 solicits input information from the user, for example, known health conditions, social factors (e.g., socio-economic status), lifestyle factors (e.g., diet and exercise level), and family health history. The user enters this information via a user interface 410; the user is also able to modify the information supplied by profile 405 via user interface 410. This user-supplied input information is stored in profile 405.

Health risk assessment tool 400 generates output information, including risk levels of contracting particular health conditions or diseases, a wellness score, and reports about the particular health conditions or diseases the user is likely to contract. The output information is stored in profile 405 and is presented to the user (not shown). The risk levels measure the likelihood of the user contracting particular health conditions or diseases from a set of predetermined conditions, e.g. breast cancer, chronic lung conditions, chronic musculoskeletal conditions, colon cancer, depression, diabetes, heart disease, high-risk pregnancy, lung cancer, prostate cancer and stroke. The risk levels are high, medium and low, but other graduation schemes can be used in alternate embodiments.

The wellness score is an overall measure of the user's health, expressed as a single number from 0-100. To generate the wellness score, health risk assessment tool 400 compares the input information with accepted medical standards, and weights each item of information according to its impact on the user's overall health.

Each report about the particular health condition the user is likely to contract describes the particular condition, its effects upon the user, and provides advice on how to avoid contracting the condition. Thus, if the user has a high risk for heart disease, the report for this condition would recommend the user quit smoking, reduce his or her fat and cholesterol intake, and maintain a moderate exercise program (assuming these factors were present in the input information to tool 400).

A Health Savings Account optimizer tool 415 generates output to assist the user in planning an amount of Health Savings Account (HSA) funds to accumulate over the user's remaining lifetime to pay for health-care expenses not covered by health insurance. HSA optimizer tool 415 estimates an annual series of health-care expenses for each year of the user's remaining life based on characteristics of the user and the effect those expenses have on the user's HSA balance. U.S. patent application Ser. No. 11/566,286, filed on Dec. 4, 2006, entitled “Method And System For Optimizing Fund Contributions To A Health Savings Account”, describes a Health Savings Account optimizer tool that can be used with embodiments of the present invention.

HSA optimizer tool 415 obtains input information from profile 405. This profile-supplied information includes three types of information: (1) information that was present in profile 405 before execution of health risk assessment tool 400, such as the user's age and gender, (2) information that was supplied by user interface 410 during the execution of tool 400, such as the user's known health conditions, and (3) information solicited by tool 415 that was supplied by the output of tool 400, such as the user's risks of contracting health conditions and the user's wellness score.

As with tool 400, HSA optimizer tool 415 solicits input information from the user via a user interface 420. The user-supplied input information includes the user's geographic region of residence, years until the user's retirement, the user's geographic region of retirement, and the user's health insurance plan parameters (such as insurance coverage amounts, insurance co-pay requirements, and insurance costs). Again, the user is able to modify the information from profile 405 via user interface 420. The user-supplied input information is stored in profile 405.

HSA optimizer 415 generates output information, including a series of projected health-care costs over the user's remaining lifetime. HSA optimizer tool 415 also allocates the health-care costs into out-of-pocket expenses, health insurance plan covered expenses, and Health Savings Account covered expenses. Finally, HSA optimizer tool 415 generates a running balance of the user's HSA and recommends an optimum annual contribution amount. All of this output information is stored in profile 405 and is presented to the user (not shown).

HSA optimizer 415 projects medical expenses for each year of the user's remaining life based on actuarial data. Because similar individuals tend to experience similar medical expenses, HSA optimizer 415 increases the accuracy of these projections by using actuarial data from a group of individuals that have characteristics similar to the user's characteristics. Health risk assessment tool 400 supplies information to HSA optimizer tool 415, via profile 405, that allows HSA optimizer tool 415 to infer that the user will contract particular health conditions or diseases sometime during their remaining life based on the risk level. High risk level conditions are assumed to occur in five years, medium risk level conditions are assumed to occur in ten years, and low risk level conditions are assumed not to occur (these time periods vary in different embodiments). By enabling HSA optimizer 415 to better match the actuarial data to the user's future conditions, health and personal planning system 100 enables HSA optimizer tool 415 to generate more accurate output information based on the information in profile 405 supplied by health risk assessment tool 400.

For example, health risk assessment tool 400 projects that the user has a high risk level for contracting heart disease based on a number of factors. This information is stored in profile 405. HSA optimizer 415 receives this information from profile 405 and infers that the user is likely to incur additional medical expenses due to heart disease beginning in five years. Thus, HSA optimizer 415 will look to actuarial data for similar individuals who have heart disease when projecting the user's medical expenses during the applicable years of the user's remaining life.

Similarly, HSA optimizer 415 uses the wellness score to adjust the series of medical expenses for each year of the user's remaining life. Because the wellness score is an overall measure of the user's health, HSA optimizer 415 increases or decreases each amount of medical expenses in the entire series to reflect that the user may have medical expenses that are higher or lower than the actuarial data associated with similarly situated individuals.

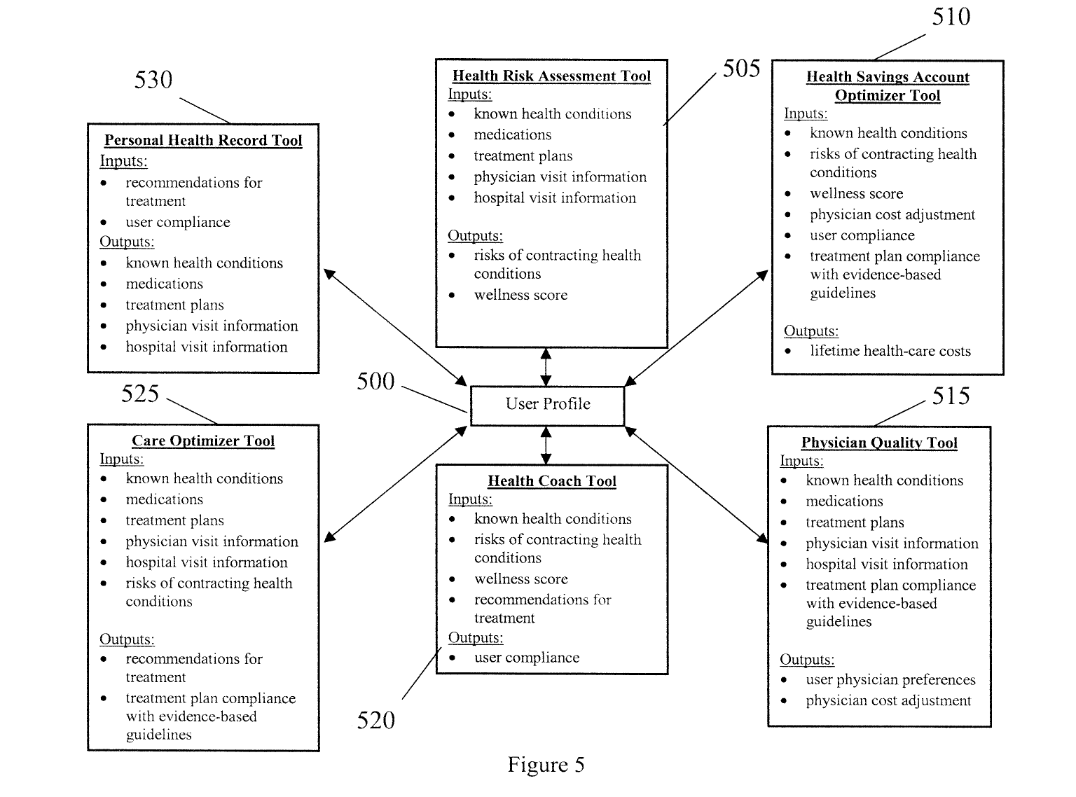

FIG. 5 shows the data flow for another specific example of health and personal planning system 100. FIG. 5 illustrates the interaction between multiple health-related information tools. In this illustration, only the input and output information shared between the tools via a user profile 500 is listed in each tool representation. As above, the examples of the tools are simplified for clarity, and separate user interfaces for each tool have been omitted from the figure. Thus, each tool is capable of producing more information than what is shown in the figure, and each tool is capable of operating on additional input information. In addition, the invention encompasses additional and/or different tools that operate on the information in profile 500.

Various health-related information tools add to or modify the information in user profile 500. A health risk assessment tool 505, similar to the tool described in connection with FIG. 4, solicits known health conditions, current and past medications, current and past treatment plans, information from physician office visits (e.g. biometric data or diagnoses), and information from hospital visits (e.g. procedures or surgeries performed) from profile 500. Health risk assessment tool 505 operates on the information provided by profile 500 and generates risks of the user contracting particular health conditions or diseases and a wellness score. This information is added to profile 500.

A Health Savings Account optimizer tool 510, similar to the tool described in connection with FIG. 4, receives information from profile 500, operates on the information, and generates information that is stored in profile 500. As in the previous example, HSA optimizer tool 510 uses the risks of the user contracting a particular health condition and the wellness score, supplied to profile 500 by health risk assessment tool 505, to more accurately estimate the user's future medical expenses. However, HSA optimizer tool 510 also uses a physician cost adjustment factor and a user compliance measurement, supplied by profile 500, to adjust the user's estimated future medical expenses. As explained in greater detail below, a physician quality tool 515 generates the physician cost adjustment factor and a health coach tool 520 generates the user compliance measurement, both of which are added to user profile 500.

Physician quality tool 515 generates output to assist the user in selecting a physician within a particular geographic area based on a set of criteria. The user supplies his or her location, specifies the type of specialist sought, and ranks how important various performance measures are to him or her (e.g., number of patients treated, mortality rate, complication rate, length of hospital stay, and cost). Using a database of physicians and associated performance measures, tool 515 presents to the user a list of physicians who most closely match the user's needs and preferences. U.S. patent application entitled “System And Method For Analyzing And Presenting Physician Quality Information”, incorporated above, describes a physician quality tool that can be used with the present invention.

For example, the user ranks the number of patients treated, mortality rate, and complication rate as highly important; the user ranks the length of hospital stay and cost as minimally important; the user specifies her location as zip code 47711; and the user indicates the desire to find a physician for a coronary bypass surgery. In response to this input, physician quality tool 515 generates a list of cardiac surgeons in the Evansville, Ind. area that have the best performance measures in the categories of number of patients treated, mortality rate, and complication rate. The user's preferences regarding performance measures and the recommended physicians are added to profile 500.

As mentioned above, physician quality tool 515 contains data that categorizes physicians according to cost. This information is used in combination with a history of encounters the user has had with the healthcare system to generate the physician cost adjustment factor for the user. The encounter history information is supplied by profile 500 and includes known health conditions, current and past medications, current and past treatment plans, information from physician office visits, and information from hospital visits. Physician quality tool 515 identifies the physician involved in each encounter, assigns a relative cost measurement for each encounter (e.g., a percentage of the average cost of all physicians for similar encounters), and generates the physician cost adjustment factor. Thus, if the user has, on the whole, used relatively more expensive physicians, physician quality tool 515 will store in profile 500 a physician cost adjustment factor that infers that the user's future medical expenses will be higher than those of similarly situated individuals. As explained above, this physician cost adjustment factor is used by HSA optimizer tool 510 to more accurately estimate the user's future medical expenses.

Also as mentioned above, health coach tool 520 provides a user compliance measure to profile 500. Health coach tool 520 provides the user with lifestyle modification programs designed to improve the user's health based on information provided by profile 500. Through input solicited from the user, health coach tool 520 also monitors the user's compliance with the recommendations of the lifestyle modification programs and generates a user compliance measure. This user compliance measure is added to profile 500.

Health coach tool 520 solicits known health conditions, risks of the user contracting health conditions in the future, and the wellness score from profile 500. Tool 520 also requests from profile 500 recommendations for medical treatment generated from a care optimizer tool 525, discussed in greater detail below. Health coach tool 520 uses this information to identify lifestyle changes that the user can make to improve the user's health. Because health coach tool 520 is informed of the risks of the user contracting health conditions in the future, health coach tool 520 can recommend changes to avoid contracting those specific conditions in addition to the known conditions.

A lifestyle modification program is created based on these lifestyle changes. The program is created from predefined sets of recommendations based on remedying particular health conditions. Thus, based on the user's known health conditions and the other input solicited from profile 500, health coach tool 520 creates a lifestyle modification program to match the user's health needs. In alternate embodiments, a health professional can create a lifestyle modification program based on the information solicited by health coach tool 520.

The user compliance measure generated by health coach tool 520 and stored in profile 500 is used by HSA optimizer tool 510 to infer whether the user's current state of health is likely to improve or degrade in the future. If the user strictly complies with the recommended lifestyle changes, the user's health is likely to improve. Conversely, if the user does not follow the recommendations of the programs, the user's health is not likely to improve, and in fact may degrade. Thus, HSA optimizer tool 510 uses the user compliance measure to adjust the estimated future medical expenses the user is likely to incur. A user with a high measure of compliance is expected to have lower medical expenses than similarly situated individuals with a low measure of compliance.

As previously mentioned, the results generated by health coach tool 520 are made more accurate by using recommendations for medical treatment for the user stored in profile 500. Care optimizer tool 525 generates this information and adds it to profile 500. These recommendations for medical treatment are distinguished from the lifestyle modification programs recommended by health coach tool 520. The recommendations for medical treatment are suggestions directed to the user's physicians founded on evidence-based guidelines given the user's current health status. Whereas, the lifestyle modification programs are a set of actions and/or behaviors that the user embraces to improve their health.

Care optimizer tool 525 solicits the user's known health conditions, current and past medications, current and past treatment plans, information from physician office visits, information from hospital visits, and risks of the user contracting health conditions from profile 500. Tool 525 then evaluates the treatment the user is currently undergoing in light of the user's current and likely future health conditions by comparing the user's actual medical treatment against evidence-based guidelines. The evidence-based guidelines are a set of medical care guidelines for given health conditions or disease states based on outcome evidence. For example, it has been shown that individuals with high blood pressure benefit from taking diuretics. Thus, one evidence-based guideline for physicians is to prescribe a diuretic medication to a patient diagnosed with high blood pressure.

The following is an example of the operation of care optimizer tool 525. Tool 525 processes the information solicited from profile 500 to determine the user's known health conditions and ascertains that the user has suffered a heart attack in the past. Evidence-based guidelines dictate that individuals who have suffered a heart attack may benefit from treatment with a beta-blocker medication. Care optimizer tool 525 then evaluates the information from profile 500 to determine if the user is current taking a beta-blocker medication. Because the user is not currently taking a beta-blocker, care optimizer tool 525 adds a recommendation to profile 500 that the user's physician evaluate whether such a medication should be prescribed for the user. Other tools soliciting information from profile 500 can act on this recommendation by informing the user or the user's physician about the apparent divergence between the user's current medical treatment and the evidence-based guidelines. Similarly, physician quality tool 515 can use these individual treatment plan compliance measures to adjust the physician quality information associated with the patient's current physician.

Care optimizer tool 525 also adds to profile 500 an overall measure of the user's treatment plans' compliance with the evidence-based guidelines for the user's various known and suspected future conditions. This overall measure of compliance differs from the user compliance measure in that this overall measure of the user's treatment plans' compliance evaluates the treatment plans, not the user. Other health-related tools use this overall treatment plan compliance measure as a relative measure of the quality of the user's healthcare. Thus, HSA optimizer tool 510 can use this measure to adjust the user's estimated future medical expenses in a manner similar to how HSA optimizer tool 510 uses the user compliance measure—a high degree of overall treatment plan compliance is likely to result in lower medical expenses than similarly situated individuals with a lower treatment plan compliance measure.

A personal health record tool 530 provides communications to the user and the user's physicians. This tool solicits input from various sources, including the user, the user's physicians, hospitals from which the user has received medial treatment, and other health professionals that have provided healthcare services to the user (e.g., laboratory tests and analyses). Personal health record tool 530 adds a wide variety of information to profile 500 that has been reported to the tool. For example, this tool supplies the user's known health conditions (e.g., such as those diagnosed by the user's physicians), current and past medications, current and past treatment plans, information gathered during physician office visits (e.g., biometric and test data), and information gathered from the user's hospitalizations (e.g. procedures and surgeries performed) to profile 500. As explained above, various health-related information tools use this information to infer information about the user to increase the accuracy of the output generated by the tools.

Personal health record tool 530 also solicits information from profile 500, including the recommendations for medical treatment and the user compliance measure supplied to profile 500 by the other tools described above. Personal health record tool 530 uses this information to inform the user and/or the user's physicians of a potential need to modify the user's current medical treatment. For example, personal health record tool 530 generates a set of electronic mail notifications and sends these notifications to the user and the relevant physicians to inform them of the potential for improvement in the user's healthcare. Thus, if the information in profile 500 indicates the user's current treatment plans do not comply with evidence-based guidelines or that the user is not complying with prescribed treatment plans, personal health record tool 530 indicates this condition.

Although not shown in either FIG. 4 or 5, a health-related terminology tool supplies information to and modifies information in profile 500. U.S. patent application Ser. No. 10/654,503, filed Sep. 3, 2003, entitled “Personalized Health History System With Accommodation For Consumer Health Terminology”, and U.S. patent application Ser. No. 11/219,591, filed Sep. 1, 2005, bearing the same title, both herein incorporated by reference, describe health-related terminology tools that can be used with embodiments of the present invention.

The health-related terminology tool solicits information from profile 500 and filters from that information codes or terms that correspond to one or more health-related concepts stored in a health related terminology thesaurus and stores identifiers that uniquely identify a corresponding health-related concept in profile 500. Some of the terms or codes received from profile 500 are clinical medical terms or codes, which are typically used by medical professionals, while other terms or codes are lay medical terms or codes. Each of the health-related terms is associated with a single identifier that uniquely identifies a corresponding health-related concept. The several health-related concepts can have a parent/child relationship (e.g., arrhythmia is a child concept of the parent concept heart disease) and a functional relationship (e.g., high blood pressure causes a stroke). The health-related terminology tool adds the related concepts to profile 500 for use by other tools.

For example, the health-related terminology tool solicits the user's known medical conditions stored in profile 500. This information reveals the user has a “type 2 sugar disease”. The parent/child concept relationships allow the term “type 2 sugar disease”, which equates to the concept of “adult-onset diabetes mellitus”, to be related as a child concept to “diabetes mellitus”, which in turn is a child concept of “diabetes”, which in turn is a child concept of “endocrine and glandular disorders”. The health-related terminology tool stores these related concepts in profile 500.

Care optimizer tool 525 solicits these parent concepts from profile 500 and, as described above, correlates the parent concepts with evidence-based guidelines for treatment of conditions associated with the parent concepts. Thus, because the profile indicates the user has diabetes, care optimizer tool 525 evaluates the information from profile 500 to determine if the user has received a recent foot exam. If not, care optimizer tool 525 adds a recommendation to profile 500 that the user receive a foot exam.

As these examples illustrate, health and personal planning system 100 permits a variety of health-related and person information tools to contribute and change information stored in the user profile. These contributions enable a tool to draw inferences about the user based on output from another tool. The ability to draw inferences that would not be available absent system 100 improves the accuracy of the output generated by the tools.

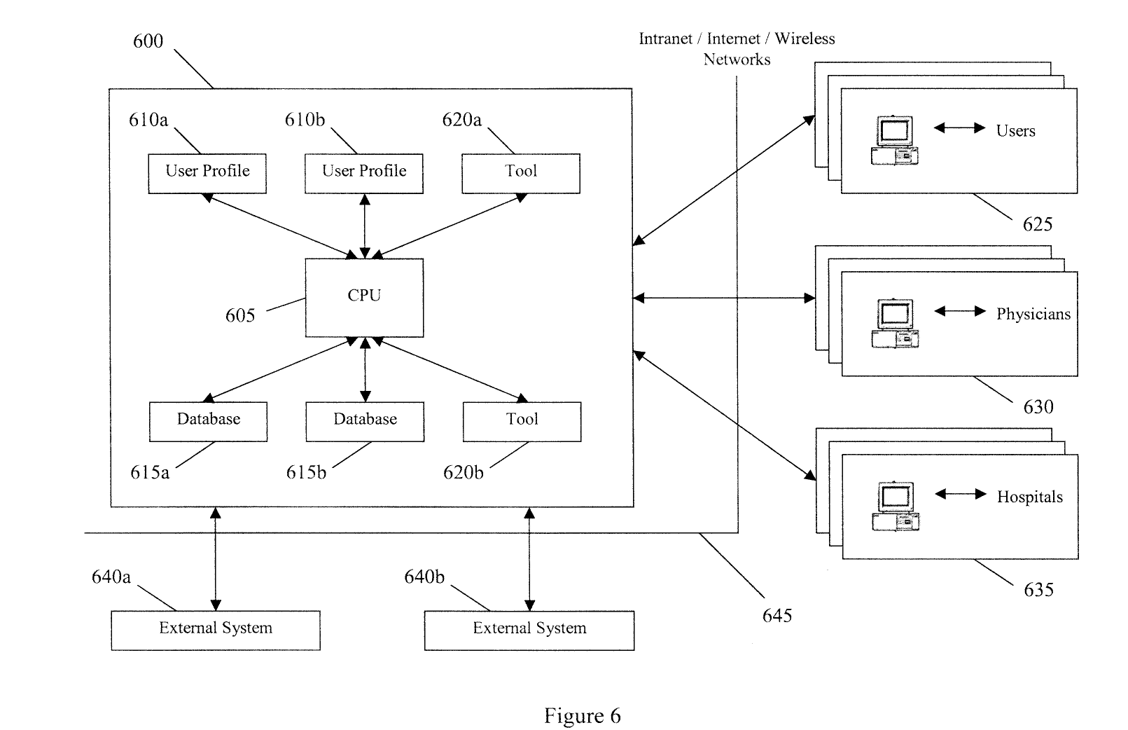

The above describes the benefits of a user profile. FIG. 6 is a conceptual diagram of one implementation of the systems and techniques used in conjunction with the embodiments described herein. In one implementation, a remote system 600 is comprised of one or more servers or remote computers. For the sake of simplicity, only one server is described. The server includes one or more central processing units 605, one or more user profiles 610a-b, one or more databases 615a-b, and one or more health-related or personal information tools 620a-b. As described above, user profiles 610a-b receive information from a variety of sources. Thus, one or more user interfaces 625, one or more physician interfaces 630, one or more hospital interfaces 635, and one or more external systems 640a-b communicate with remote system 600 via networks 645. Networks 645 can be private or public and can be a direct connection, a local or wide area network, a wireless network, or an intranet. In this illustrative implementation, networks 645 include the Internet.

Health-related or personal information tools 620a-b solicit information from, add information to, and modify information in profiles 610a-b via CPU 605. Similarly, CPU 605 can access information stored in databases 615a-b. User interfaces 625, physician interfaces 630, and hospital interfaces 635 include computers that run health-related and personal information tools, such as those described above. The tools that run on interfaces 625, 630, and 635 include, for example, stand-alone applications that execute instructions on the computers included in these interfaces as well as instructions executed on the computers distributed via a web browser (e.g., HTML script or JavaScript). Thus, these interfaces also access CPU 605 to solicit information from, add information to, and modify information in profiles 610a-b.

The system presents information to the user, the user's physicians, or others via interfaces 625, 630, and 635, as well as external systems 640a-b. For example, in addition to other conventional means, user interfaces 625 include web browser-based display screens that present the information contained in user profiles 610a-b, output generated by tools 620a-b, and output generated by tools running on user interfaces 625. External systems 640a-b provide information to individuals from user profiles 610a-b and tools 620a-b via conventional means, such as electronic mail, facsimile, and printed reports.

As will be realized, other embodiments are within the following claims. Accordingly, the drawings and description are to be regarded as illustrative in nature and not in a restrictive or limiting sense with the scope of the application being indicated in the claims.

What is claimed is:

1. A computer-implemented method comprising:
storing a patient profile in electronic storage, said patient profile including personal and medical information about a patient;
providing access to a set of different health-related information tools, wherein each of the different health-related information tools is a corresponding computer program which when executed uses information from the patient profile to generate corresponding health-related information about the patient and stores additional information about the patient in the patient profile, wherein the additional information stored by each of the different health-related information tools includes health-related information generated by that tool; and
providing an interface enabling the patient to execute any selectable one of the health-related information tools among the set of different health-related information tools, wherein the additional information stored in the patient profile by a first health-related information tool of the set is used by a second health-related information tool of the set during execution to generate its output.

2. The method of claim 1, wherein the additional information stored by the second health-related information tool in the patient profile is used by the first health-related information tool during execution to generate its output.

3. The method of claim 1, further comprising soliciting personal and medical information about the patient from the patient and storing the solicited information in the patient profile.

4. The method of claim 1, further comprising soliciting personal and medical information about the patient from a physician who has provided medical treatment to the patient and storing the solicited information in the patient profile.

5. The method of claim 1, further comprising generating personal and medical information about the patient based on interactions between the patient and a medical information system and storing the information in the patient profile.

6. The method of claim 1, further comprising generating personal and medical information about the patient based on information obtained from a complementary medical information system and storing the information in the patient profile.

7. The method of claim 1, wherein the first health-related information tool is for assessing risks of the patient contracting predetermined health conditions, and the additional information generated and stored by the first health-related information tool that is used by the second health-related information tool during execution includes at least one of a relative measure of the overall health and patient risk levels of the patient contracting one or more health conditions.

8. The method of claim 7, wherein the second health-related information tool is for assisting the patient in determining an amount of funds to contribute to a Health Savings Account, and the additional information used by the second health-related information tool to generate an estimate of future medical expenses of the patient includes at least one of the relative measure of the overall health and the risk levels of the patient contracting one or more health conditions.

9. The method of claim 1, wherein the first health-related information tool is for assisting the patient in selecting a physician, and the additional information generated and stored by the first health-related information tool that is used by the second health-related information tool during execution includes a physician cost adjustment factor, said physician cost adjustment factor for measuring a cost of medical treatment of the patient relative to at least one of an average cost for said medical treatment or an actual cost for said medical treatment.

10. The method of claim 1, wherein the first health-related information tool is for providing lifestyle modification programs designed to improve the health of the patient, and the additional information generated and stored by the first health-related information tool that is used by the second health-related information tool during execution includes a relative measure of the compliance of the patient with the lifestyles modifications provided by the first health-related information tool.

11. The method of claim 1, wherein the first health-related information tool is for providing recommendations for medical treatment for the patient, and the additional information generated and stored by the first health-related information tool that is used by the second health-related information tool during execution includes at least one of recommendations for medical treatment for the patient and a relative measure of the compliance of current treatment plans of the patient for known medical conditions with evidence-based guidelines for treatment of said known medical conditions.

12. The method of claim 1, wherein the additional information generated and stored by the first health-related information tool that is used by the second health-related information tool during execution includes at least one of known health conditions of the patient, current medications being taken by the patient, past medications taken by the patient, current treatment plans of the patient, medical test results of the patient, and medical procedures the patient has undergone.

13. The method of claim 1, wherein the second health-related information tool is for providing lifestyle modification programs designed to improve the health of the patient, and the additional information used by the second health-related information tool to generate its output includes at least one of known health conditions of the patient, a relative measure of the overall health of the patient, risk levels of the patient contracting one or more health conditions, and recommendations for medical treatment for the patient.

14. The method of claim 1, wherein the second health-related information tool is for assessing risks of the patient contracting predetermined health conditions, and the additional information used by the second health-related information tool to generate its output includes at least one of known health conditions of the patient, current medications being taken by the patient, past medications taken by the patient, current treatment plans of the patient, medical test results of the patient, and medical procedures the patient has undergone.

15. The method of claim 1, wherein the second health-related information tool is for assisting the patient in detennining an amount of funds to contribute to a Health Savings Account, and the additional information used by the second health-related information tool to generate its output includes at least one of known health conditions of the patient, a relative measure of the overall health of the patient, risk levels of the patient contracting one or more health conditions, a relative measure of the compliance of the patient with treatment recommendations, a relative measure of the compliance of current treatment plans of the patient for known medical conditions with evidence-based guidelines for treatment of said known medical conditions, and a physician cost adjustment factor for measuring a cost of medical treatment of the patient relative to an average cost for said medical treatment.

16. The method of claim 1, wherein the second health-related information tool is for assisting the patient in selecting a physician, and the additional information used by the second health-related information tool to generate its output includes at least one of known health conditions of the patient, current medications being taken by the patient, past medications taken by the patient, current treatment plans of the patient, medical test results of the patient, medical procedures the patient has undergone, and a relative measure of the compliance of current treatment plans of the patient for known medical conditions with evidence-based guidelines for treatment of said known medical conditions.

17. The method of claim 1, wherein the second health-related information tool is for providing recommendations for medical treatment for the patient, and the additional information used by the second health-related information tool to generate its output includes at least one of known health conditions of the patient, current medications being taken by the patient, past medications taken by the patient, current treatment plans of the patient, medical test results of the patient, medical procedures the patient has undergone, and risk levels of the patient contracting one or more health conditions.

18. The method of claim 1, wherein the second health-related information tool is for providing health-related communications to a physician treating the patient, and the additional information used by the second health-related information tool to generate its output includes at least one of recommendations for medical treatment for the patient and a relative measure of the compliance of the patient with treatment recommendations.

19. A computer-implemented method comprising:
storing a patient profile in electronic storage, said patient profile including personal and medical information about a patient;
providing access to a set of different health-related information tools, wherein each of the different health-related information tools is a corresponding computer program which when executed uses information from the patient profile to generate corresponding health-related information about the patient and stores at least some of the generated corresponding health-related information in the patient profile as additional information from that health-related information tool; and
providing an interface enabling the patient to execute any selectable one of the health-related information tools among the set of different health-related information tools, wherein the any selectable one of the health-related information tools employs the additional information stored in the patient profile by at least one of the other health-related information tools of the set of different health-related information tools.

20. A system comprising:
a computer system;
a patient profile stored on the computer system, said patient profile including personal and medical information about a patient;
first program code on a computer-readable medium, which when executed on the computer system uses information from the patient profile to generate corresponding health-related information about the patient and stores at least some of the generated corresponding health-related information in the patient profile as additional information;
second program code on a computer-readable medium, which when executed on the computer system uses information from the patient profile, including at least some of the additional information of the first program code, to generate corresponding health-related information about the patient and stores at least some of the generated corresponding health-related information in the patient profile as additional information; and
third program code on a computer-readable medium, which when executed on the computer system presents at least some of the health-related information generated by at least one of the first and second program code to the user.

21. The system of claim 20, wherein the computer system comprises a local patient computer and a remote server, the local patient computer and remote server enabled for electronic communication.

22. The system of claim 21, wherein at least one of the first and second program code is executed on the local patient computer.
